(19) United States
(12) Patent Application Publication
(10) Pub. No.: US 2016/0068071 A1
(43) Pub. Date: Mar. 10, 2016

(54) DEVICE FOR INDUCTIVELY TRANSMITTING ENERGY AND METHOD FOR OPERATING AN INDUCTIVE ENERGY-TRANSMISSION DEVICE

(71) Applicant: ROBERT BOSCH GMBH, Stuttgart (DE)

(72) Inventor: Bernd ECKERT, Stuttgart (DE)

(21) Appl. No.: 14/785,885

(22) PCT Filed: Mar. 27, 2014
(86) PCT No.: PCT/EP2014/056181

§ 371 Date: Oct. 21, 2015

(30) Foreign Application Priority Data
Apr. 22, 2013 (DE) 10 2013 207 198.1

(51) Int. Cl. B60L 11/18; G01V 8/10; H02J 5/00

(52) U.S. Cl. CPC B60L 11/182; H02J 5/005; G01V 8/10

(57) ABSTRACT

The present invention relates to the monitoring of an intermediate space, in particular the air gap, between a transmitting coil and a receiving coil during inductive energy transmission. Said intermediate space is monitored by means of an optical monitoring device. By means of optical monitoring of the air gap between the transmitting coil and the receiving coil, the entry of an object can be reliably detected without the magnetic field of the inductive energy transmission being influenced.

### BACKGROUND OF THE INVENTION

The present invention relates to a device for inductively transmitting energy from a transmitting coil to a receiving coil spaced apart from the transmitting coil as well as to a method for operating an inductive energy-transmission device.

Electric vehicles are usually equipped with an electric energy store, for example a traction battery, which provides the electric energy for the drive. If this electric energy store is completely or partially discharged, the electric vehicle has to head for a charging station, at which the energy store can be recharged. Up until now, the electric vehicle is usually connected to the charging station by means of a cable connection. This connection must typically be manually produced by the user. As a result, it is required that the charging station and the electric car have a connecting system that corresponds to each other.

In addition, wireless charging systems for electric vehicles are also occasionally known. To this end, an electric vehicle is switched off via a coil. This coil transmits an alternating magnetic field. The alternating magnetic field is received by a receiving coil inside of the vehicle and converted into electrical energy. A fraction battery of the vehicle can subsequently be charged by means of this electric energy. The German patent publication DE 10 2011 010 049 A1 discloses such a system for charging a vehicle battery, in which the energy is inductively transmitted.

The energy store of the electric vehicle can furthermore be used for the feedback of energy. To this end, a cable connection or also an inductive power transmission can also be used.

During the wireless charging of a battery of an electric vehicle, an air gap is situated between the transmitting coil of the charging station and the receiving coil in the vehicle. Due to the required ground clearance of motor vehicles, this air gap can amount to a number of centimeters. Air gaps in the range of 15-25 cm are therefore very widely used if an ideal small air gap is not achieved by measures like lowering the coil fixed on the vehicle, lowering the entire vehicle or raising the stationary coil or a combination of these measures. Due to the highly magnetic fields, it is however not desirable that objects, such as, for example, contaminants or animals are located in said air gap.

There is therefore the need for an inductive energy-transmission device which can reliably detect an object in the transmission region of the inductive energy transmission path.

### SUMMARY OF THE INVENTION

According to one aspect, the present invention relates to a device for the inductive energy-transmission from a transmitting coil to a receiving coil spaced apart from the transmitting coil, said device comprising an optical monitoring device which is designed to monitor an intermediate space between the transmitting coil and the receiving coil.

According to a further aspect, the present invention relates to a method for operating an inductive energy-transmission device, comprising the following steps: providing a transmitting coil, providing a receiving coil, inductively transmitting energy from the transmitting coil to the receiving coil and monitoring the intermediate space between the transmitting coil and the receiving coil by means of an optical monitoring device.

A concept of the present invention is to monitor the air gap of an inductive energy transmission path during the energy transmission by means of an optical monitoring device and in so doing to ensure that no foreign bodies are present in this air gap or can enter into said air gap.

An important advantage of the present invention is that absolutely no interfering foreign bodies are therefore located in the intermediate space between transmitting coil and receiving coil during the entire energy transmission. Intruding foreign bodies could otherwise significantly jeopardize the energy transmission. For example, animals which enter into the intermediate space between transmitting coil and receiving coil can suffer injuries due to the highly magnetic field. In addition, there is the risk that intruding objects, in particular objects containing metal, heat up on account of the strong magnetic field and can even catch fire in some cases. Such an entry of animals as well as from other foreign bodies can be reliably detected by means of the inventive monitoring of the intermediate space. If need be, suitable measures can subsequently be initiated.

A further advantage of the invention is that the magnetic field of the energy transmission is not disturbed particularly by means of an optical monitoring of the intermediate space between transmitting and receiving coil. The magnetic field for the energy transmission and the light beams of the monitoring device do not influence one another; thus enabling the energy transmission to take place in an unimpeded manner without being influenced in any way by the optical monitoring.

According to one embodiment of the invention, the optical monitoring device is a light barrier, an optical rangefinder, an optical scanner and/or a light curtain. Such optical systems are particularly well suited to monitoring air gaps as they occur as intermediate spaces during the inductive energy-transmission.

In one embodiment of the invention, the inventive device for inductively transmitting energy further comprises a cleaning device which is designed to clean the optical monitoring device. Because optical systems particularly tend to become contaminated by environmental influences, as, for example, dust or airborne dirt, the reliability of the optical monitoring of the intermediate space can be significantly increased by such a cleaning device.

According to a further embodiment of the inventive device, the optical monitoring device is designed to detect an entry of an object into the intermediate space between transmitting coil and receiving coil and to deactivate the transmitting coil if an entry of an object has been detected. In this way, the inductive energy transmission can be abruptly stopped. As a result, an intruding object is not subjected to the magnetic field of the transmitting coil.

The present invention further relates to a battery charging device comprising an inventive energy transmitting device.

In one embodiment of the invention, the inventive method for operating the inductive energy-transmission device further comprises the steps of detecting an object in the intermediate space between the transmitting coil and the receiving coil and the interrupting of the energy transmission if an object is detected in the intermediate space between the transmitting coil and the receiving coil. In the event of an object being detected, the detected object is no longer subjected to the alternating magnetic field as a result of such an interruption of the energy transmission. Thus, further negative consequences, such as, for example, excessive heating of the intruding object or something similar, can be prevented.

In a further embodiment of the invention, the inventive method further comprises a step for signaling the detection of an object in the intermediate space between the transmitting coil and the receiving coil. By means of this signaling of an object in the intermediate space, a user can quickly detect the entry of the object and thereupon immediately initiate suitable counter measures. If the transmitting coil is simultaneously deactivated when the object enters the intermediate space and consequently a charging process for the battery is interrupted, the user can then quickly react as a result of the detection being signaled, remove the intruding foreign body and subsequently continue the charging process.

### BRIEF DESCRIPTION OF THE DRAWINGS

Further features and advantages of embodiments of the invention ensue from the following description with reference to the attached drawings.

In the drawings:

FIG. 1 shows a schematic depiction of a cross section through a vehicle comprising an inductive energy-transmission device according to one embodiment of the invention;

FIG. 2 shows a schematic of an optical monitoring according to one embodiment of the invention;

FIG. 3 shows a schematic depiction of an optical monitoring according to a further embodiment of the invention;

FIG. 4 shows a schematic depiction of an optical monitoring according to a further embodiment of the invention; and

FIG. 5 shows a schematic depiction of a method for operating an inductive energy-transmission device according to one embodiment of the invention.

### DETAILED DESCRIPTION

The drawings depicted in the figures are in part perspective depictions of elements which, for reasons of clarity, are not necessarily depicted true to scale. Similar reference signs generally denote similar or similarly functioning components.

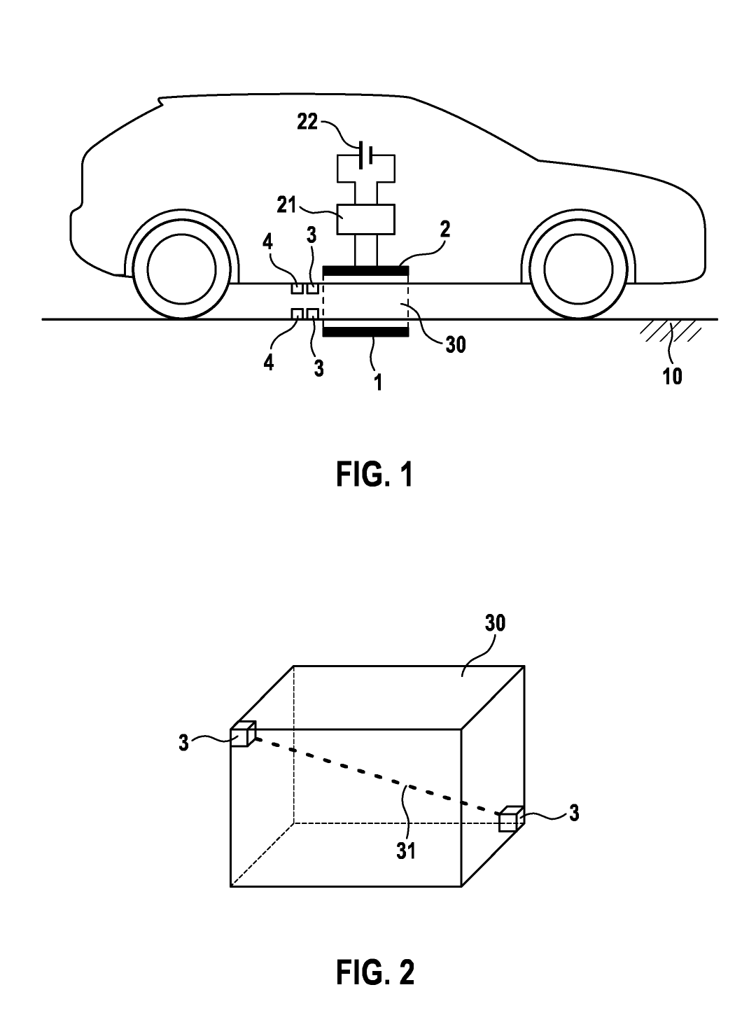

FIG. 1 shows a vehicle 20 which is parked over an inductive charging station. The vehicle 20 is parked in such a manner that the receiving coil 2 of the vehicle 20 is disposed above the transmitting coil 1. Due to the required ground clearance of the vehicle 20, an intermediate space 30 with an air gap exists between the ground 10 in which the transmitting coil 1 is disposed and the underside of the vehicle 20 in which the receiving coil 2 is located. This intermediate space 30 comprising the air gap can thereby amount to a plurality of centimeters. In the case of vehicle models typical today, air gaps between 15 and 25 cm are to be expected. Other sizes for the intermediate space between ground 10 and underside of the vehicle are however also possible. Said intermediate space 30 is normally readily accessible. For that reason, the possibility exists that living beings or objects can enter into said intermediate space 30 at any time. Thus, animals, such as cats or mice, can, for example, enter into said space. There is furthermore also the danger that objects such as, for example, dirt, garbage, leaves or something similar can enter into said intermediate space 30. Especially easily combustible objects containing metal constitute a serious danger during the inductive charging process because said objects can excessively heat up and as a result possibly ignite.

After the vehicle 20 has been parked in such a manner that the receiving coil 2 in the vehicle 20 is located above the transmitting coil 1, the charging of the traction battery 22 can begin. To this end, the transmitting coil 1 generates an alternating magnetic field. This alternating magnetic field is received by the receiving coil 2 and converted into electrical energy. This electrical energy is subsequently available for charging the traction battery via a suitable circuit 21.

In order to feed electrical energy from the vehicle 20 back into an energy supply network, the coil in the vehicle can also inversely serve as a transmitting coil which generates a magnetic field. The coil in the charging station then operates as a receiving coil which receives the energy of the magnetic field and converts said energy into electric energy. This electric energy can subsequently be fed into an energy supply network.

In order to ensure that absolutely no undesirable objects are located in the intermediate space 30 during the inductive energy transmission from the transmitting coil 1 to the receiving coil 2, said intermediate space 30 is monitored by an optical monitoring device 3.

FIG. 2 shows, for example, the monitoring of the intermediate space 30 by means of a light barrier. In order to improve the view, only a single light barrier is depicted between two corner points. A plurality of light barriers is however also possible for the inventive approach of an optical monitoring of the intermediate space 30. In so doing, the intermediate space 30 can be still more reliably monitored in the entire volume thereof by the use of a plurality of light barriers.

Such a light barrier comprises at least one light source, which transmits a light beam, and a light sensor which detects the light of the light source. If the light beam is thereby interrupted or attenuated, i.e. weakened, in the course thereof, this fact can then be detected by the detector. It is also furthermore possible to deflect the light beam emitted by the light source by means of one or a plurality of mirrors and thus to arrive at a more complex profile of the light beam 31. As a result, a very good monitoring of the volume in the intermediate space 30 can already be achieved.

The reliability of such a light barrier technology can, for example, still additionally be improved by means of a combination with an optical distance measurement. In so doing, an optical distance measurement usually uses coherent light, for example laser light. Thus, such an optical distance measurement can also detect the entry of an object if the emitted light beam would arrive at the detector in another way due to the undesirable reflections.

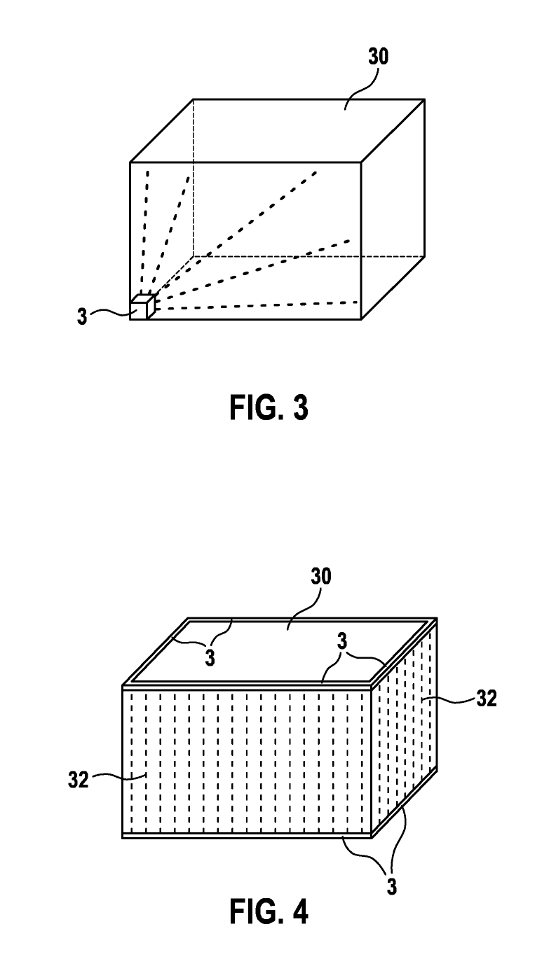

FIG. 3 shows a further embodiment for the optical monitoring of the intermediate space 30. The volume of the intermediate space 30 is thereby monitored by an optical scanner. Such an optical scanner can, for example, relate to a laser scanner.

FIG. 4 shows a further embodiment for the optical monitoring of the intermediate space 30. In this case, the outer edge of the intermediate space 30 is monitored by one or a plurality of light curtains. If an object then penetrates through a surface monitored by such a light curtain, said object is thus detected and signaled by the light curtain. To this end, a light curtain between two edges lying opposite one another can create respectively one beam grid 32 which is partially interrupted upon entry of an object. In this embodiment of the optical monitoring by means of a light curtain, only the outer edge of the intermediate space 30 is monitored. Prior to initiating the charging process, it must therefore be ensured that a foreign body is not located in the intermediate space 30 at the starting point in time.

Besides the options depicted in connection with the methods depicted in FIGS. 2 to 4, there are, of course, also further options for the optical monitoring of the intermediate space 30 which are possible.

The optical monitoring devices used comprise at least active elements, such as, for example, a light source which emits one or a plurality of light beams and detector elements which receive and evaluate the emitted light. In addition, the optical monitoring devices 3 can also comprise passive elements. The monitoring devices 3 can, for example, also have mirrors or other reflectors which reflect or deflect the light emitted by the light sources. In order to optically monitor the intermediate space 30, it is, for example, possible that all active optical elements, i.e. light sources and detectors, are either located on the vehicle 20 or on the charging station, i.e. on the ground 10. The respectively other side is furnished exclusively with passive components, such as mirrors or reflectors. Hence, the charging station can, for example, emit one or a plurality of light beams for monitoring the intermediate space 30, said light beams being subsequently reflected by reflectors on the underside of the vehicle and thrown back to the detectors at the charging station. It is likewise alternatively possible for the light sources to be mounted on the underside of the vehicle 20 and for the light to be reflected by reflectors in the region of the transmitting coil 2 and subsequently led back to detectors on the underside of the vehicle.

In an alternative embodiment, it is also additionally possible for respectively active optical elements to be mounted in the charging station with the transmitting antenna 1 as well as on the vehicle with the receiving antenna 2. For example, the light can be emitted from the underside of the vehicle and be detected by detectors at the charging station in the region of the transmitting antenna 1. Alternatively, the opposite is also possible that the light is emitted from light sources in the region of the transmitting antenna and is evaluated by detectors on the underside of the vehicle in the region of the receiver antenna 2. In addition, mixed forms are also possible.

In the present case of an inductive energy transmission from a charging station to an electric vehicle 20, the elements of the optical monitoring device at the charging station as well as on the vehicle are thereby very greatly exposed to environmental influences. For that reason, contamination of the optical monitoring device can, for example, occur from dust or airborne dirt. In this case, a reliable monitoring of the intermediate space 30 between transmitting antenna 1 and receiving antenna 2 would no longer be possible. A cleaning device 4 can therefore be furthermore provided, which cleans the elements of the optical monitoring device 3 and thus frees said elements of impurities. Such a cleaning device 4 can, for example, clean the elements of the optical monitoring device 3 by means of a suitable water jet. To this end, the cleaning device 4 can have one or a plurality of nozzles, from which water can stream under a suitable pressure. Such a cleaning device can, for example comprise a tank for a cleaning fluid, such as, for example, water, a pump and one or a plurality of nozzles. Further options for cleaning the optical monitoring device 3 are likewise possible.

In order to clean the optical monitoring device, it is, for example possible that the optical elements on the vehicle are cleaned in the region of the receiving antenna 2 already while driving. The monitoring device 3 is therefore available for use and can be immediately put to use upon the vehicle being shut down. It is also alternatively possible to first clean the optical elements of the monitoring device 3 when shutting down the vehicle or when initiating the charging process.

In the same way, the optical elements of the monitoring device 3 can also be freed of impurities in the region of the transmitting antenna 1 by a cleaning device 4. In so doing, this cleaning device 4 can continuously clean the optical elements around the transmitting antenna 1 either at regular intervals or alternatively only then if a vehicle is parked over the charging device or if the charging process is initiated.

In order to clean the optical monitoring device 3, it is possible for separate cleaning devices, which are specially adapted to the respective arrangement of the optical monitoring device, to be used in each case in the region of the transmitting antenna and in the region of the receiving antenna in the vehicle. Alternatively, it is likewise possible for only one cleaning device 4 to be disposed either on the vehicle 20 or in the charging station in the region of the transmitting antenna 1 and to clean the optical elements in the region of said transmitting antenna 1 as well as in the region of the receiving antenna 2 by means of this single cleaning device.

If the vehicle 20 is now parked with the receiving antenna 2 over the charging station with the transmitting antenna 1 and, as the case may be, if the optical monitoring device 3 has been cleaned by the cleaning device 4, the charging of the fraction battery 22 can now be started. To this end, a data link is, if applicable, initially established between the vehicle 20 and the charging station. Such a data link is preferably a wireless connection. The link can, for example, be produced optically, for example on the basis of infrared light, by means of a radio link, such as, for example, WLAN, GSM, Bluetooth, etc. or by means of an inductive connection between vehicle and charging station. An authorization of the vehicle and/or the driver of the vehicle can initially take place by means of such a data link. In addition, the exchange of vehicle specific parameters as well as the transmission of parameters for a later deduction of the costs is also possible. If all of the required data have been exchanged and if the charging process is to subsequently begin, the monitoring device 3 is then initially checked as to whether the intermediate space 30 between transmitting antenna 1 and receiving antenna 2 is free. If the monitoring device 3 detects in the process that an undesirable object is situated in the intermediate space 30, the charging process is therefore not started.

If, on the other hand, the intermediate space 30 is free, the transmitting antenna 1 generates a magnetic field. This magnetic field is received by the receiving antenna 2 and converted into electric energy. This electric energy is supplied to the battery 22 of the vehicle 20 via a suitable circuit 21. The vehicle battery 22 is charged in this way.

If, during the charging process, it is detected by means of the optical monitoring device 3 that an object has entered into the intermediate space 30 between transmitting antenna 1 and receiving antenna 2, the monitoring device 3 can thus initially emit a warning signal. If the intermediate space 30 is thereupon cleared of the detected object within a predetermined time period, the charging process is then continued without interruption. It is, for example, therefore conceivable that an intruding animal was frightened by the warning signal and left the intermediate space 30 as a result. A further possibility, for example, is that a user located in close proximity can immediately remove the intruding object upon the warning signal being sounded and thus avoid greater damage from incurring.

If, on the other hand, the detected object is not removed from the intermediate space 30 within a predefined time period, the charging process is thereupon interrupted by the transmitting coil 1 being deactivated. Greater damage incurred from the intruding object can thus be prevented.

It is also alternatively possible to immediately deactivate the transmitting coil 1 and therefore to stop the charging process upon detecting an intruding object. This can be particularly useful when using a light curtain as depicted in FIG. 4. A suitable warning signal can optionally be emitted even when the charging process is immediately shut down and the transmitting coil 1 is deactivated.

The optical monitoring device 3 can also further be coupled to an additional notification device (not shown), which sends out a notice to the user if an object is detected in the intermediate space 30. This can, for example, relate to notifying the user via a mobile telephone connection or to sending out a notice via a suitable additional radio communication. The user himself/herself can thus be informed about the entry of an object into the intermediate space 30 if he/she is not in the immediate proximity of the vehicle. Because the charging process of an electric vehicle can generally last several hours, it is also possible that the user is at a remote location during this time. Even in these instances, the user can also be informed of a disturbance which is occurring by means of a notification via a radio signal, which was described above. Upon receiving notification, the user can proceed to his/her vehicle, remove the disturbing object and subsequently continue the charging process anew.

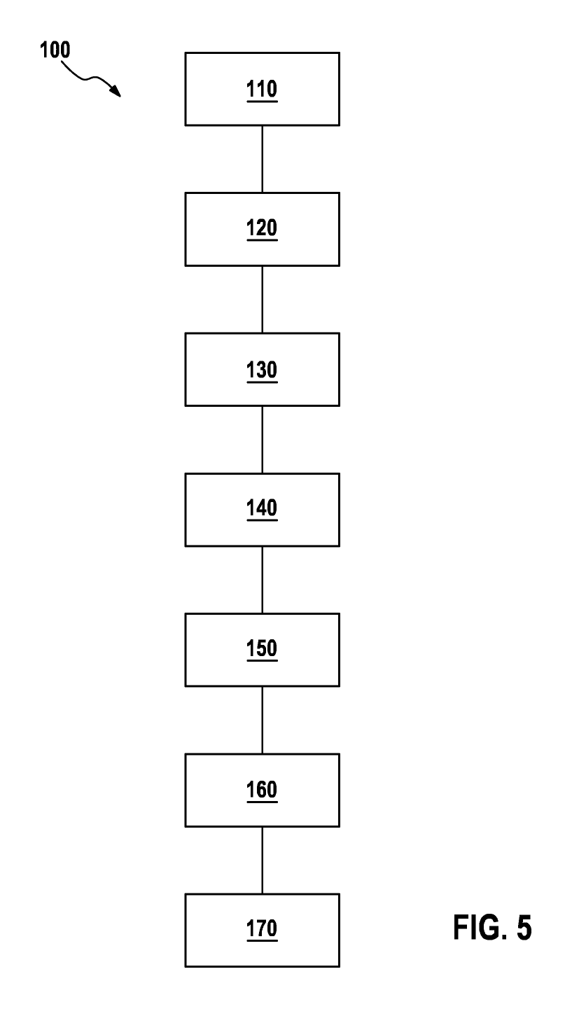

FIG. 5 shows a schematic depiction of a method 100 for operating an inductive energy-transmission device, as said device can, for example, be used to charge a traction battery in an electric vehicle. In a first step 110, a transmitting coil 1 is provided. Said transmitting coil can, for example, relate to the transmitting coil of a charging station for the electric vehicle. In a further step 120, a receiving coil 2 is provided. This can, for example, relate to the receiving coil in the electric vehicle, with which the traction battery is to be recharged. In step 130, energy is transmitted inductively from the transmitting coil 1 to the receiving coil 2. In step 140, the intermediate space between the transmitting coil 1 and the receiving coil 2 is furthermore monitored with an optical monitoring device 3.

In step 150, the entry of an object into the intermediate space 30 between transmitting coil 1 and receiving coil 2 can furthermore be detected, and the energy transmission between transmitting coil 1 and receiving coil 2 can subsequently be interrupted in step 160 if an object has been detected in the intermediate space 30.

In step 170, a signaling can optionally take place if an object has been detected in the intermediate space 30 between transmitting coil 1 and receiving coil 2. This signaling can, for example, relate to the outputting of an optical and/or acoustic signal. Additionally or alternatively, the notification of a remote user can also furthermore take place by means of a radio connection. To this end, a mobile telephone connection, a WLAN connection or something similar can, for example, be used.

In summary, the present invention relates to the monitoring of an intermediate space, in particular an air gap, between a transmitting coil and a receiving coil during an inductive energy transmission. The monitoring of said intermediate space takes place by means of an optical monitoring device. By optically monitoring the air gap between transmitting coil and receiving coil, the entry of an object into said intermediate space can be reliably detected without the magnetic field of the inductive energy transmission being affected.

1. A device for inductively transmitting energy from a transmitting coil to a receiving coil which is spaced apart from the transmitting coil, the device comprising:
an optical monitoring device which is designed to monitor an intermediate space between the transmitting coil and the receiving coil.

2. The device according to claim 1, wherein the optical monitoring device is a light barrier, an optical rangefinder, an optical scanner, a light curtain.

3. The device according to claim 1, comprising a cleaning device which is designed to clean the optical monitoring device.

4. The device according to claim 1, wherein the optical monitoring device is designed to detect an entry of an object into the intermediate space between the transmitting coil and the receiving coil and to deactivate the transmitting coil if an entry of an object has been detected.

5. A battery charging device comprising:
a transmitting coil;
a receiving coil spaced apart from the transmitting coil; and
an optical monitoring device configured to monitor an intermediate space between the transmitting coil and the receiving coil.

6. A method for operating an inductive energy-transmission device, comprising the following steps:
providing a transmitting coil;
providing a receiving coil;
inductive energy transmission from the transmitting coil to the receiving coil; and
monitoring the intermediate space between the transmitting coil and the receiving coil with an optical monitoring device.

7. The method according to claim 6, further comprising the steps:
detecting an object in the intermediate space between the transmitting coil and the receiving coil; and
interrupting the energy transmission if an object has been detected in the intermediate space between transmitting coil and receiving coil.

8. The method according to claim 7, further comprising for signaling the detection of an object in the intermediate space between the transmitting coil and the receiving coil.
